(19) United States
(12) Patent Application Publication
(10) Pub. No.: US 2026/0245251 A1
(43) Pub. Date: Aug. 20, 2026

(54) METHOD AND DEVICES FOR ALIGNING A THREE-DIMENSIONAL REFLECTOR

(71) Applicant: Robert Bosch GmbH, Stuttgart (DE)

(72) Inventors: Hans Mai, Goeppingen (DE); Armin Ruoff, Lenningen (DE); Dirk Schoenfeld, Altbach (DE); Georg Wagner, Filderstadt (DE); Mauro Disaro, Stuttgart (DE); Reiner Leikert, Muenchen (DE); Simon Ehmann, Weinstadt (DE)

(21) Appl. No.: 19/156,726

(22) PCT Filed: Feb. 8, 2024
(86) PCT No.: PCT/EP2024/053159

§ 371 Date: Aug. 14, 2025

(30) Foreign Application Priority Data
Mar. 16, 2023 (DE) 10 2023 202 405.5

(51) Int. Cl. G06T 7/80; G01S 7/40; G01S 13/931; G02B 7/182; G02B 26/08; H01Q 15/14

(52) U.S. Cl. CPC G06T 7/85; G01S 7/4004; G01S 13/931; G02B 7/1828; G02B 26/0816; H01Q 15/14; G01S 2013/9323; G01S 2013/93274; G01S 2013/9329; G06T 2207/30204; G06T 2207/30252

(57) ABSTRACT

A method for aligning a three-dimensional reflector provided for calibrating a sensor of a driver assistance system. The method includes: attaching a pointer device to the three-dimensional reflector; mounting the reflector on a stand and, with the aid of the pointer device, aligning it in terms of height with respect to a sensor which is to be calibrated and which is installed in a motor vehicle; attaching a reflector-adapter device in a predefined position and alignment on a calibration device; arranging the calibration device in a predefined position and alignment in front of the motor vehicle in which the sensor is installed; and positioning the stand, on which the three-dimensional reflector is mounted, on the reflector-adapter device in such a way that at least one reference surface of the stand is aligned with at least one corresponding reference surface of the reflector-adapter device.

### FIELD

The present invention relates to a method for aligning a three-dimensional reflector provided for calibrating a sensor of a driver assistance system. The present invention also relates to a pointer device for aligning the three-dimensional reflector with respect to a motor vehicle and to a reflector-adapter device for aligning the three-dimensional reflector to a calibration tool provided for calibrating driver assistance systems.

### BACKGROUND INFORMATION

For calibrating driver assistance systems, such as those often installed in motor vehicles, calibration devices with one or more measuring panels (“calibration panels”) are used, particularly in workshops. At least one optical pattern is formed on each of the calibration panels, which pattern is optically detectable by an image recording device of a driver assistance system to be calibrated in order to calibrate the driver assistance system. Radar reflector plates can also be provided that enable radar sensors to be calibrated.

Some manufacturers require the use of three-dimensional reflectors (“triple reflectors”) to calibrate their radar sensors or driver assistance systems. Until now, special devices have been required to correctly position such three-dimensional reflectors in front of the vehicle.

It is an object of the present invention to simplify the use of three-dimensional reflectors (“triple reflectors”) for calibrating driver assistance systems.

### SUMMARY

A method according to an example embodiment of the present invention for aligning a three-dimensional reflector (“triple reflector”) provided for calibrating a sensor of a driver assistance system comprises: attaching a pointer device to the three-dimensional reflector; mounting the reflector on a stand and, with the aid of the pointer device, aligning it in terms of height with respect to a sensor that is to be calibrated and that is installed in a motor vehicle; attaching a reflector-adapter device in a predetermined position and alignment on a calibration device; arranging the calibration device in a predetermined position and alignment in front of the motor vehicle in which the sensor is installed; and positioning the stand on which the three-dimensional reflector is mounted on the reflector-adapter device in such a way that at least one reference surface of the stand is aligned with at least one corresponding reference surface of the reflector-adapter device.

According to an example embodiment of the present invention, the at least one reference surface of the stand can in particular abut the at least one corresponding reference surface of the reflector-adapter device.

After the three-dimensional reflector has been aligned according to the present invention, the pointer device and the calibration device are removed so as not to negatively influence the subsequent calibration.

The present invention also comprises a pointer device for aligning a three-dimensional reflector provided for calibrating a sensor of a driver assistance system. The pointer device comprises a reference surface provided to abut a corresponding surface of the three-dimensional reflector; a pointer extending away from the reference surface; and at least one support surface designed to support the pointer device on the reflector. The pointer can in particular be rod-shaped and/or aligned orthogonally to the reference surface.

The present invention further comprises a reflector-adapter device for aligning a three-dimensional reflector, which is provided for calibrating a sensor of a driver assistance system, with respect to a calibration device. The reflector-adapter device comprises at least one reference surface designed to align a corresponding reference surface of a three-dimensional reflector or a stand for a three-dimensional reflector; and a fastening region designed to fasten the reflector-adapter device to the calibration device.

The present invention also comprises a system for aligning a three-dimensional reflector provided for calibrating a sensor of a driver assistance system. The system comprises a stand for supporting the three-dimensional reflector; a pointer device according to the present invention; an adapter device according to the present invention; a calibration device designed to support the adapter device; and a measuring and alignment system that allows the calibration device to be arranged in a predetermined position and alignment in front of a motor vehicle.

The present invention makes it possible to align a three-dimensional reflector in front of a motor vehicle using a conventional calibration device such as those used to align conventional two-dimensional reflectors. Therefore, no additional calibration device is required that is specifically provided and designed to align the three-dimensional reflector. In this way, the effort and costs of using three-dimensional reflectors to calibrate automotive sensors can be kept low.

In one example embodiment of a pointer device according to the present invention, the at least one support surface is aligned at an angle, in particular at a right angle, to the reference surface. With such a support surface, the pointer device can be attached particularly well to a three-dimensional reflector.

In one example embodiment of the present invention, an opening for receiving a region of the three-dimensional reflector is formed between the at least one support surface and the reference surface of the pointer device. In this way, the pointer device can be attached particularly well to a three-dimensional reflector. The opening can in particular be slot-shaped.

In one example embodiment of the present invention, the fastening region of the reflector-adapter device has a fastening surface which is designed for fastening to the calibration device. The fastening surface can in particular be aligned orthogonally to the at least one reference surface.

In one example embodiment of the present invention, the fastening region or the fastening surface is magnetic and/or provided with magnets, so that the reflector-adapter device can be magnetically fastened to the calibration device. In this way, the reflector-adapter device can be attached to the calibration device particularly easily and securely, but detachably.

In one example embodiment of the present invention, the reflector-adapter device has a connecting region extending between the fastening region and the at least one reference surface. The connecting region can in particular be designed with a grid structure in order to keep the weight of the reflector-adapter device as low as possible.

The reflector-adapter device can be made of plastics material or metal, in particular a bent or folded metal sheet.

In one example embodiment of the present invention, the reflector-adapter device has two reference surfaces which are designed to align corresponding reference surfaces of a three-dimensional reflector and/or of a stand for a three-dimensional reflector. In particular, the two reference surfaces can be aligned orthogonally to each other. In this way, the three-dimensional reflector can be positioned precisely in two dimensions on the floor of the measuring station.

### BRIEF DESCRIPTION OF THE DRAWINGS

FIG. 1 shows a schematic representation of a plan view of a measuring station with a motor vehicle and a calibration device, according to an example embodiment of the present invention.

FIG. 2 shows a perspective front view of a calibration device for calibrating sensors of driver assistance systems and a stand with a three-dimensional reflector, according to an example embodiment of the present invention.

FIG. 3 shows a perspective representation of a reflector-adapter device which is designed according to an exemplary embodiment of the present invention.

FIGS. 4 and 5 each show an enlarged representation of the interaction between a reflector-adapter device according to an example embodiment of the present invention and the stand.

FIG. 6 shows a perspective view of a pointer device according to an example embodiment of the present invention.

FIG. 7 shows a three-dimensional reflector to which a pointer device according to an example embodiment of the present invention is attached.

### DETAILED DESCRIPTION OF EXAMPLE EMBODIMENTS

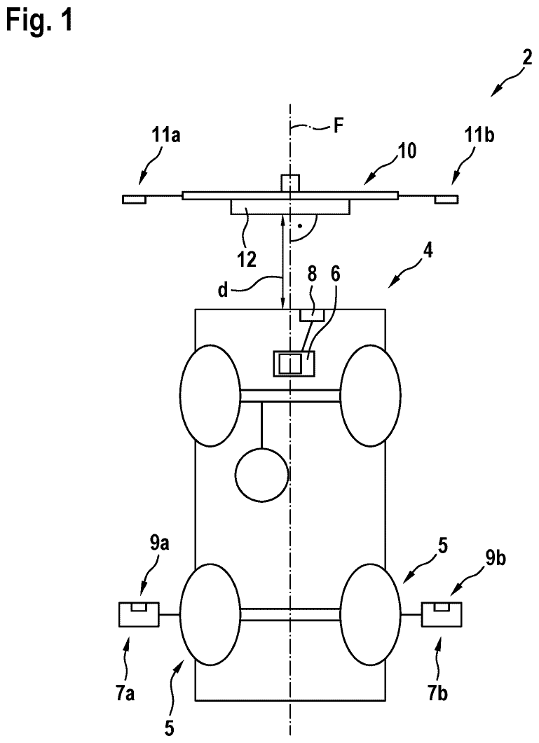

FIG. 1 shows a schematic plan view of a measuring station 2 with a motor vehicle 4 which is equipped with a driver assistance system 6. The driver assistance system 6 has at least one sensor 8. The sensor 8 can be, for example, an image recording device (camera) and/or a radar sensor.

A calibration device (“calibration tool”) 10 is positioned in front of the motor vehicle 4.

The calibration device 10 shown in FIG. 1 comprises a central calibration panel 12 and/or two lateral calibration panels 11a, 11b on which optical patterns are formed that can be detected by optical sensors.

With the aid of measuring devices, e.g., measuring heads 7a, 7b, which have optical sensors 9a, 9b and which can be attached for example to the rear wheels 5 of the motor vehicle 4, the position and alignment of the calibration device 10 with respect to the motor vehicle 4 can be determined. In this way, the calibration device 10 can be positioned in a predetermined position and alignment in front of the motor vehicle 4. The calibration device 10 is usually aligned orthogonally to the longitudinal axis F of the motor vehicle 4 and arranged at a predetermined distance d in front of the motor vehicle 4.

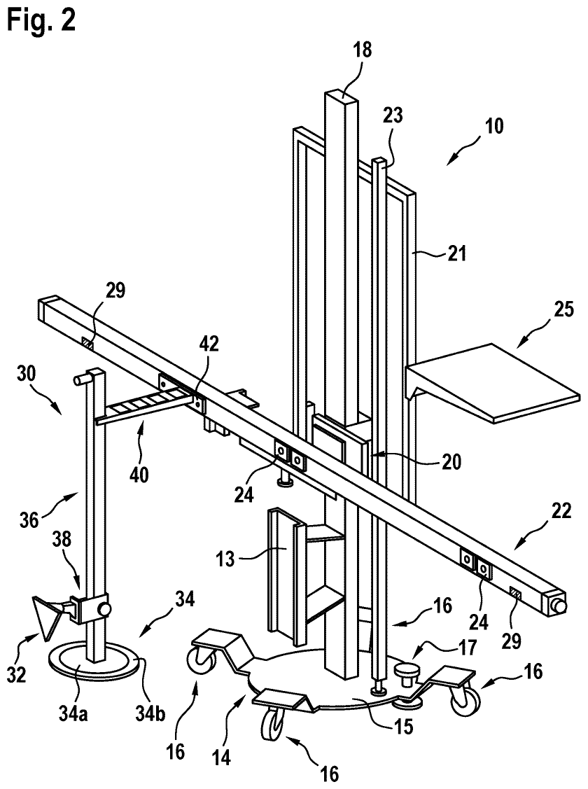

FIG. 2 shows a perspective front view of the calibration device 10. The calibration panels 11a, 11b, 12 are not shown in FIG. 2, since they are not required for the use of the calibration device 10 according to the present invention.

The calibration device 10 comprises a column 18 which is supported on a base 14 and which extends substantially in the vertical direction.

The base 14 has a base plate 15 which is aligned substantially horizontally.

On the underside of the base plate 15 facing the floor, rollers 16 are attached which enable the calibration device 10 to be moved on the floor of the measuring station 2.

In a region at the rear in FIG. 2, two adjustable feet 17 are provided, which make it possible to level the base plate 15 so that the base plate 15 is aligned horizontally, or to level the base plate 15 so that the column 18 is aligned as precisely as possible vertically. In FIG. 2, only one of the two adjustable feet 17 is visible.

On the side of the column 18 facing the motor vehicle 4, a spacer plate 13 is attached which can be brought into contact with a front of a motor vehicle 4 in order to align the calibration device 10 as precisely as possible with respect to the motor vehicle 4. For the use of the calibration device 10 according to the present invention, the spacer plate 13 is not required.

A support device 20 is supported on the column 18 in such a way that the support device 20 can be moved along the column 18 in the vertical direction. The support device 20 can be fixed, e.g. with the aid of a clamping device, at different positions along the column 18, i.e., at different heights above the floor of the measuring station 2.

The support device 20 supports a beam-shaped carrier 22 which extends substantially orthogonally to the column 18, i.e. substantially in the horizontal direction.

Sensors (e.g. “spirit levels”) not shown in FIG. 2 may be provided on the carrier 22, which make it possible to align the carrier 22 as precisely as possible horizontally.

A plurality of holding devices 24 are formed on the carrier 22, which holding devices make it possible to attach at least one calibration panel 12 (not shown in FIG. 2) to the carrier 22. The holding devices 24 can be movable along the carrier 22.

The holding devices 24 and the at least one calibration panel 12 can for example be designed such that the at least one calibration panel 12 can be fixed to one of the holding devices 24 by magnetic force.

By moving the support device 20 along the column 18, the height of the carrier 22 and thus also the height of calibration panels 12 attached to the carrier 22 above the floor of the measuring station 2 can be changed and set to a desired value. By moving the holding devices 24 along the carrier 22, the positions of the calibration panels 12 attached to the carrier 22 can be changed in the horizontal direction.

Image recording devices 29 or camera modules can also be provided on or in the carrier 22, which devices or modules are designed to record images of a motor vehicle 4 arranged in front of the calibration device 10 in order to be able to determine the position of the calibration device 10 with respect to the motor vehicle 4.

In particular, two image recording devices 29 or camera modules can be provided which are arranged on different sides of the column 18 on the carrier 22 and in this way make it possible to record a three-dimensional image of a motor vehicle 4 arranged in front of the calibration device 10.

With the aid of such image recording devices 29, it can be determined mechanically and automatically whether the calibration device 10 is positioned in the correct alignment and position in front of the motor vehicle 4.

In or on the column 18, a tension spring (not visible in FIG. 2) can be provided which is mechanically connected to the support device 20 in order to support the movement of the support device 20 along the column 18, in particular an upward movement of the support device 20 against the force of gravity.

The support device 20 can be fixed to the column 18 in a desired position or height by a clamping device.

A frame 21 is also attached to the column 18, which frame simplifies the handling of the calibration device 10.

A measuring ruler 23 that extends substantially parallel to the column 18, orthogonally to the floor of the measuring station 2, is attached to the frame 21. The measuring ruler 23 makes it possible to read off the height of the support device 20 along the column 18 and to adjust it to a desired value with high accuracy.

A shelf 25, which extends horizontally substantially parallel to the floor of the measuring station 2, is also attached to the frame 21.

For example, a computer, in particular a laptop, which is used to calibrate the driver assistance system 6, can be placed on the shelf 25.

The calibration device 10 shown in FIG. 2 is shown only as an example. Instead of the calibration device 10 shown in FIG. 2, other calibration devices 10 can also be used if they allow a reflector-adapter device 40 to be attached to the calibration device 10.

In front of the calibration device 10, a stand 30 is placed to which a three-dimensional reflector (“3D reflector”) 32 is attached.

The stand 30 has a base 34 placed on the floor of the measuring station 2 and a column 36 extending vertically upwards from the base 34. The three-dimensional reflector 32 is attached to the column 36 in a height-adjustable manner by a clamping device 38.

The base 34 can comprise a plurality of disks 34a, 34b arranged parallel to one another, which can be easily moved relative to one another for example by means of sliding films (not visible in FIG. 2) arranged between the disks 34a, 34b so that the column 36 can be easily aligned relative to the base 34 of the stand 30.

Attached to one of the holding devices 24 of the calibration device 10 is a reflector-adapter device 40, which allows the stand 30, and thus also the three-dimensional reflector 32 attached to the stand 30, to be positioned with respect to the calibration device 10 on the floor of the measuring station 2.

The reflector-adapter device 40 can be fastened mechanically, e.g. by a clamp or screw connection, or magnetically to the holding device 24 of the calibration device 10.

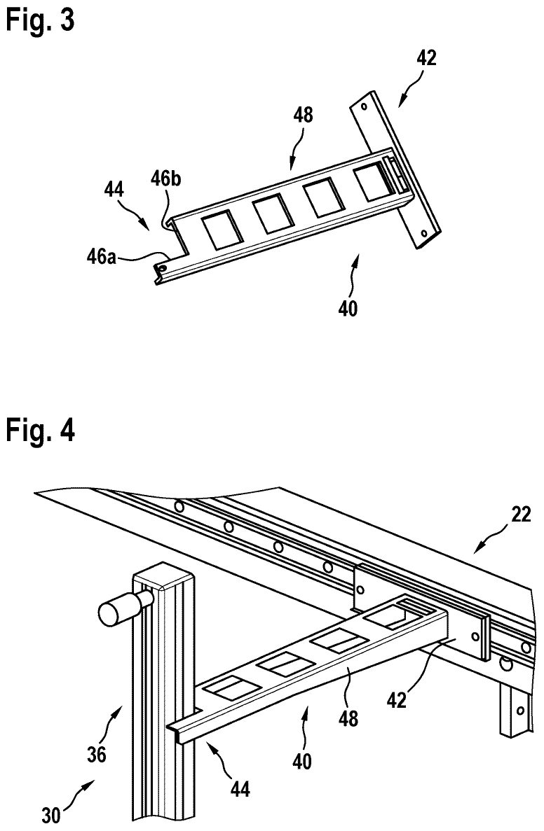

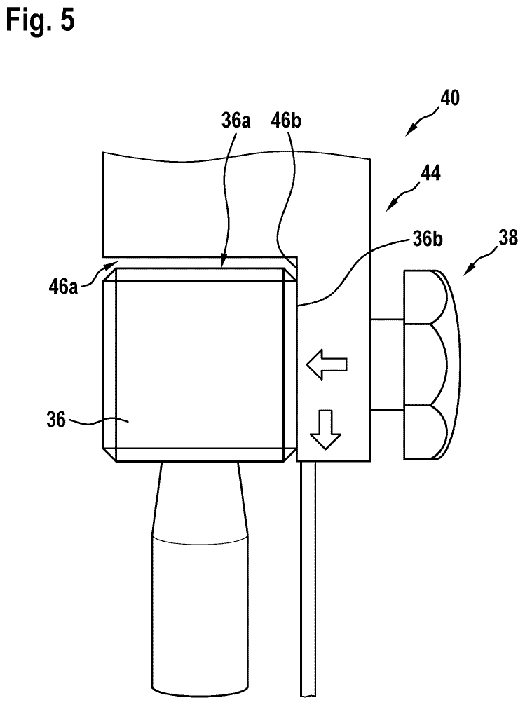

FIG. 3 shows a perspective representation of a reflector-adapter device 40 which is designed according to an exemplary embodiment of the present invention. FIGS. 4 and 5 show, in an enlarged representation, the interaction between the reflector-adapter device 40 and the column 36 of the stand 30 in order to align the stand 30 with respect to the reflector-adapter device 40.

The reflector-adapter device 40 has a fastening region 42 shown on the right in FIG. 3 and a reference region 44 shown on the left.

A connecting region 48 extends between the fastening region 42 and the reference region 44, which connecting region connects the fastening region 42 and the reference region 44 to one another. In the exemplary embodiment shown in the figures, the connecting region 48 is designed as a grid structure in order to reduce the weight of the reflector-adapter device 40.

The reflector-adapter device 40 can be made of plastics material or metal, for example folded sheet metal.

The fastening region 42 is designed to be fastened, for example by magnetic force, to one of the holding devices 24 of the calibration device 10. In the exemplary embodiment shown in the figures, the fastening region 42 is designed as a connecting plate.

The reference region 44 is provided to cooperate with the column 36 of the stand 30 in order to align the stand 30 with respect to the calibration device 10 on the floor of the measuring station 2, as shown in FIGS. 2, 4 and 5.

For this purpose, the reference region 44 has two reference surfaces 46a, 46b which are aligned at right angles to each other. In order to align the stand 30 relative to the calibration device 10, the stand 30 is arranged such that two side surfaces 36a, 36b of the column 36 of the stand 30 are aligned parallel to the two reference surfaces 46a, 46b or abut the two reference surfaces 46a, 46b, as shown in particular in FIGS. 4 and 5.

In order to arrange the stand 30 with the three-dimensional reflector 32 at a predetermined position in front of the motor vehicle 4, the height of the three-dimensional reflector 32 on the column 36 of the stand 30 is first set to a desired value, which is usually specified by the manufacturer of the sensor 8 to be calibrated.

In order to be able to correctly adjust the height of the three-dimensional reflector 32, a pointer device 50 is provided, which is temporarily attached to the three-dimensional reflector 32 for adjusting the height of the three-dimensional reflector 32.

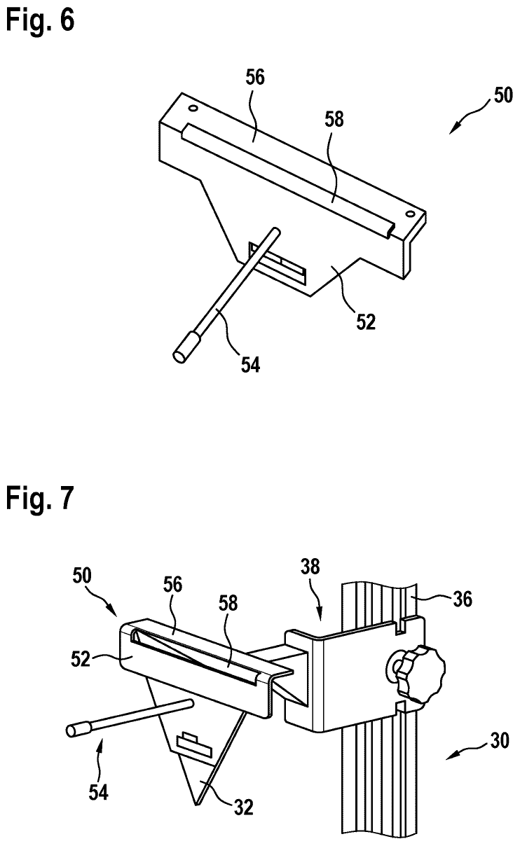

A perspective view of a pointer device 50 designed according to an exemplary embodiment of the present invention is shown in FIG. 6. FIG. 7 shows a three-dimensional reflector 32 to which a pointer device 50 according to the present invention is attached.

The pointer device 50 has a reference surface 52 or reference plate which is provided to abut a corresponding surface of the three-dimensional reflector 32 when the pointer device 50 is attached to the three-dimensional reflector 32, as shown in FIG. 7.

The pointer device 50 also has a rod-shaped pointer 54 which extends from the reference surface 52. The pointer 54 extends in particular orthogonally to the reference surface 52.

The pointer device 50 further has a support surface 56 which is designed to support the pointer device 50 on the three-dimensional reflector 32. In the exemplary embodiment shown in the figures, the support surface 56 is aligned substantially orthogonally to the reference surface 52.

An opening 58, for example a gap, is formed between the support surface 56 and the reference surface 52. In order to attach the pointer device 50 to the three-dimensional reflector 32, a region of the three-dimensional reflector 32 is inserted into the opening 58, as shown in FIG. 7.

In further exemplary embodiments not explicitly shown in the figures, the pointer device 50 can also be attached and temporarily fixed to the three-dimensional reflector 32 in some other way, e.g. magnetically.

After the pointer device 50 has been attached to the three-dimensional reflector 32, the height of the three-dimensional reflector 32 on the column 36 is adjusted using the clamping device 38 so that the pointer 54 is arranged at a predetermined height with respect to the motor vehicle 4, e.g. at the height of the manufacturer's logo, the center of the radar sensor, or another marking provided on the motor vehicle 4.

After the height of the three-dimensional reflector 32 has been set, the pointer device 50 is removed from the three-dimensional reflector 32.

In order to position the stand 30 at a predetermined position on the floor of the measuring station 2, the calibration device 10 is positioned at a predetermined position and in a predetermined alignment in front of the motor vehicle 4 using conventional means, e.g., with the aid of measuring heads 7a, 7b attached to the motor vehicle 4 or with the aid of image recording devices 29 provided on the calibration device 10.

One of the holding devices 24 of the calibration device 10 is brought into a predetermined position on the carrier 22, and the connecting region 48 of the reflector-adapter device 40 is attached to the holding device 24.

The carrier 22 is brought to a suitable height, for example to a height in the range between 80 cm and 100 cm above the floor of the measuring station 2.

The column 36 of the stand 30 is then positioned at the reference region 44 of the reflector-adapter device 40 and aligned with respect to the reference surfaces 46a, 46b of the reflector-adapter device 40, as shown in FIGS. 2, 4 and 5.

After the stand 30 with the three-dimensional reflector 32 has been positioned in the correct position on the floor of the measuring station 2, the calibration device 10 with the reflector-adapter device 40 is removed from the stand 30.

Removing the calibration device 10 is necessary in particular if the three-dimensional reflector 32 is to be used to calibrate radar sensors, since the metallic parts of the calibration device 10 can interfere with the calibration of radar sensors.

A reflector-adapter device 40 according to the present invention and a pointer device 50 according to the present invention make it possible to align a three-dimensional reflector 32 with a conventional calibration device 10. Therefore, no additional calibration device is required which is specifically provided and designed for aligning the three-dimensional reflector 32.

A reflector-adapter device 40 according to the present invention and a pointer device 50 according to the present invention therefore make it possible to keep the effort and costs for using a three-dimensional reflector 32 low.

1-10. (canceled)

11. A method for aligning a three-dimensional reflector provided for calibrating a sensor of a driver assistance system, the method comprising the following steps:
attaching a pointer device to the three-dimensional reflector;
mounting the reflector on a stand and, using the pointer device, aligning the reflector in terms of height with respect to a sensor which is to be calibrated and which is installed in a motor vehicle;
attaching a reflector-adapter device in a predetermined position and alignment on a calibration device;
arranging the calibration device in a predetermined position and alignment in front of the motor vehicle in which the sensor is installed; and
positioning the stand, on which the three-dimensional reflector is mounted, on the reflector-adapter device in such a way that at least one reference surface of the stand is aligned with at least one corresponding reference surface of the reflector-adapter device.

12. A pointer device for aligning a three-dimensional reflector which is provided for calibrating a sensor of a driver assistance system, wherein the pointer device comprises:
a reference surface provided to abut a corresponding surface of the three-dimensional reflector;
a pointer extending away from the reference surface, wherein the pointer extends orthogonally to the reference surface; and
at least one support surface configured to support the pointer device on the reflector.

13. The pointer device according to claim 12, wherein the at least one support surface is aligned at a right angle to the reference surface.

14. The pointer device according to claim 12, wherein a slot-shaped opening for receiving a region of the three-dimensional reflector is formed between the at least one support surface and the reference surface.

15. A reflector-adapter device for aligning a three-dimensional reflector, which is provided for calibrating a sensor of a driver assistance system, with respect to a calibration device, wherein the reflector-adapter device comprises:
at least one reference surface configured to align a corresponding reference surface of a three-dimensional reflector or a stand for a three-dimensional reflector; and
a fastening region which is configured to fasten the reflector-adapter device to the calibration device.

16. The reflector-adapter device according to claim 15, wherein the fastening region has a fastening surface, wherein the fastening surface is aligned orthogonally to the at least one reference surface.

17. The reflector-adapter device according to claim 15, wherein the fastening region is configured for magnetic fastening to the calibration device.

18. The reflector-adapter device according to claim 15, further comprising:
a connecting region which extends between the fastening region and the at least one reference surface, wherein the connecting region is formed with a grid structure.

19. The reflector-adapter device according to claim 15, wherein the at least one reference surface includes two reference surfaces which are configured to align corresponding reference surfaces of a three-dimensional reflector and/or of a stand for a three-dimensional reflector, wherein the two reference surfaces are aligned orthogonally to one another.

20. A system for aligning a three-dimensional reflector provided for calibrating a sensor of a driver assistance system of a motor vehicle, the system comprising:
a stand for supporting the three-dimensional reflector;
a pointer device including:
a reference surface provided to abut a corresponding surface of the three-dimensional reflector,
a pointer extending away from the reference surface, wherein the pointer extends orthogonally to the reference surface, and
at least one support surface configured to support the pointer device on the reflector;
a reflector-adapter device including:
at least one reference surface configured to align a corresponding reference surface of the three-dimensional reflector or the stand; and
a fastening region which is configured to fasten the reflector-adapter device to a calibration device;
the calibration device configured to support the reflector-adapter device; and
at least one measuring and alignment system which enables the calibration device to be positioned in a predetermined position and alignment in front of the motor vehicle.
